(19) United States
(12) Patent Application Publication
(10) Pub. No.: US 2014/0328486 A1
(43) Pub. Date: Nov. 6, 2014

(54) ANALYZING AND TRANSMITTING ENVIRONMENTAL SOUNDS

(71) Applicant: INTERNATIONAL BUSINESS MACHINES CORPORATION, Armonk, NY (US)

(72) Inventors: Divya Gopinath, Clarksburg, MD (US); Rajesh Radhakrishnan, Reston, VA (US); Jennifer A. Watson, Wasaga Beach (CA)

(73) Assignee: International Business Machines Corporation, Armonk, NY (US)

(21) Appl. No.: 13/887,440

(22) Filed: May 6, 2013

(51) Int. Cl. H04R 29/00

(52) U.S. Cl. CPC H04R 29/00
USPC 381/56

(57) ABSTRACT

Embodiments herein provide analysis and transmission of environmental sounds (e.g., outdoor sounds generated from an environment surrounding an enclosure) to an indoor occupant. Specifically, a sound analyzer is configured to receive a sensor output containing the environmental sounds, and analyze, in real-time, the environmental sounds to determine attributes of each of the environmental sounds. Each attribute is then compared to a collection of known sounds, and classified based on the comparison. The environmental sounds are then output and transmitted to the indoor occupant as at least one of: an audio transmission containing one or more of the environmental sounds, and a display of information about the one or more environmental sounds. The environmental sounds can be broadcast to the indoor occupant in real-time, and/or may be recorded for later analysis and use.

### FIELD OF THE INVENTION

The present invention relates generally to audio analysis and transmission and, more specifically, to a system configured for capturing, analyzing, and transmitting a set of outdoor environmental sounds to an indoor occupant.

### BACKGROUND OF THE INVENTION

Animals, humans, automobiles, etc., make a wide variety of sounds that may be of interest to an individual. For example, farmers, zoo keepers, pet owners, and the like have long known that many animal sounds are meaningful and relate to the animal's identity (e.g., gender, age, size, etc.), behavior, situation, and state of mind. Studies show that there can be a relationship between an animal's behavioral context (e.g., situation/motivational state) and/or identity, and measurable acoustic properties of sounds that the animal makes.

Prior approaches have also shown that the acoustic properties of vocalizations produced by humans, birds, various mammals (e.g., primates, deer, dogs, elephants, etc.), anurans and other land and sea-based animals can vary dependent on the behavioral context and/or on the size, gender, and age of the human/animal, thus making it possible, in some cases, to recognize an individual human/animal based on its vocalizations.

In addition to these vocalizations, some of the other sounds (or lack thereof) made by humans/animals, either deliberately or incidentally, are of interest because they can help to indicate the human/animal's identity, current activity, behavior, state of mind, etc.

In some situations, individuals may be interested in listening to outdoor sounds generated from an environment surrounding an enclosure (e.g., a building, dwelling, automobile, etc.). These outdoor sounds may be desirable for both pleasure and safety to an individual located within the enclosure, wherein the individual is unable to hear or otherwise observe the outdoor sounds without enhancement. Current approaches fail to provide these outdoor sounds to the individual along with useful properties of the captured outdoor sounds. Accordingly, what is needed is a solution that solves at least one of the above-identified deficiencies.

### SUMMARY OF THE INVENTION

In general, embodiments herein provide analysis and transmission of environmental sounds (e.g., outdoor sounds generated from an environment surrounding an enclosure) to an indoor occupant. Specifically, a sound analyzer is configured to receive a sensor output containing the environmental sounds, and analyze, in real-time, the environmental sounds to determine attributes of each of the environmental sounds. Each attribute is then compared to a collection of known sounds, and classified based on the comparison. The environmental sounds are then output and transmitted to the indoor occupant as at least one of: an audio transmission containing one or more of the environmental sounds, and a display of information about the one or more environmental sounds. The environmental sounds can be broadcast to the indoor occupant in real-time, and/or may be recorded for later analysis and use.

In one embodiment, there is a method for analyzing and transmitting environmental sounds. In this embodiment, the method comprises the computer-implemented steps of: receiving a sensor output containing a set of environmental sounds; analyzing the set of environmental sounds to determine attributes of each of the set of environmental sounds; comparing the attributes of each of the set of environmental sounds to a collection of known sounds; classifying each of the set of environmental sounds based on the comparison of the attributes of each of the set of environmental sounds to the collection of known sounds; and outputting one or more of the set of environmental sounds.

In another embodiment, there is a system for analyzing and transmitting environmental sounds. In this embodiment, the system comprises at least one processing unit, and memory operably associated with the at least one processing unit. A sound analyzer is storable in memory and executable by the at least one processing unit. The sound analyzer comprises a receiver component configured to receive a sensor output containing a set of environmental sounds; an analysis component configured to analyze the set of environmental sounds to determine attributes of each of the set of environmental sounds; a comparison component configured to compare the attributes of each of the set of environmental sounds to a collection of known sounds; a classification component configured to classify each of the set of environmental sounds based on the comparison of the attributes of each of the set of environmental sounds to the collection of known sounds; and an output component configured to output one or more of the set of environmental sounds.

In another embodiment, there is a computer-readable storage medium storing computer instructions, which when executed, enables a computer system to analyze and transmit environmental sounds. In this embodiment, the computer instructions comprise: receiving a sensor output containing a set of environmental sounds; analyzing the set of environmental sounds to determine attributes of each of the set of environmental sounds; comparing the attributes of each of the set of environmental sounds to a collection of known sounds; classifying each of the set of environmental sounds based on the comparison of the attributes of each of the set of environmental sounds to the collection of known sounds; and outputting one or more of the set of environmental sounds.

In another embodiment, there is a method for deploying a sound analyzer for use in a computer system that provides analysis and transmission of environmental sounds. In this embodiment, a computer infrastructure is provided and is operable to: receive a sensor output containing a set of environmental sounds; analyzing the set of environmental sounds to determine attributes of each of the set of environmental sounds; compare the attributes of each of the set of environmental sounds to a collection of known sounds; classify each of the set of environmental sounds based on the comparison of the attributes of each of the set of environmental sounds to the collection of known sounds; and output one or more of the set of environmental sounds.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a schematic of an exemplary computing environment in which elements of the present embodiments may operate;

FIG. 2 shows a more detailed view of a sound analyzer that operates with a set of external devices according to embodiments of the invention;

FIG. 3 shows an exemplary implementation of the sound analyzer according to embodiments of the invention; and

FIG. 4 shows a flow diagram for analyzing and transmitting environmental sounds according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The invention will now be described more fully herein with reference to the accompanying drawings, in which exemplary embodiments are shown. Embodiments of the invention provide analysis and transmission of environmental sounds (e.g., outdoor sounds generated from an environment surrounding an enclosure) to an indoor occupant. Specifically, a sound analyzer is configured to receive a sensor output containing the environmental sounds, and analyze, in real-time, the environmental sounds to determine attributes of each of the environmental sounds. Each attribute is then compared to a collection of known sounds, and classified based on the comparison. The environmental sounds are then output and transmitted to the indoor occupant as at least one of: an audio transmission containing one or more of the environmental sounds, and a display of information about the one or more environmental sounds. The environmental sounds can be broadcast to the indoor occupant in real-time, and/or may be recorded for later analysis and use.

This disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “computing,” “determining,” “evaluating,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

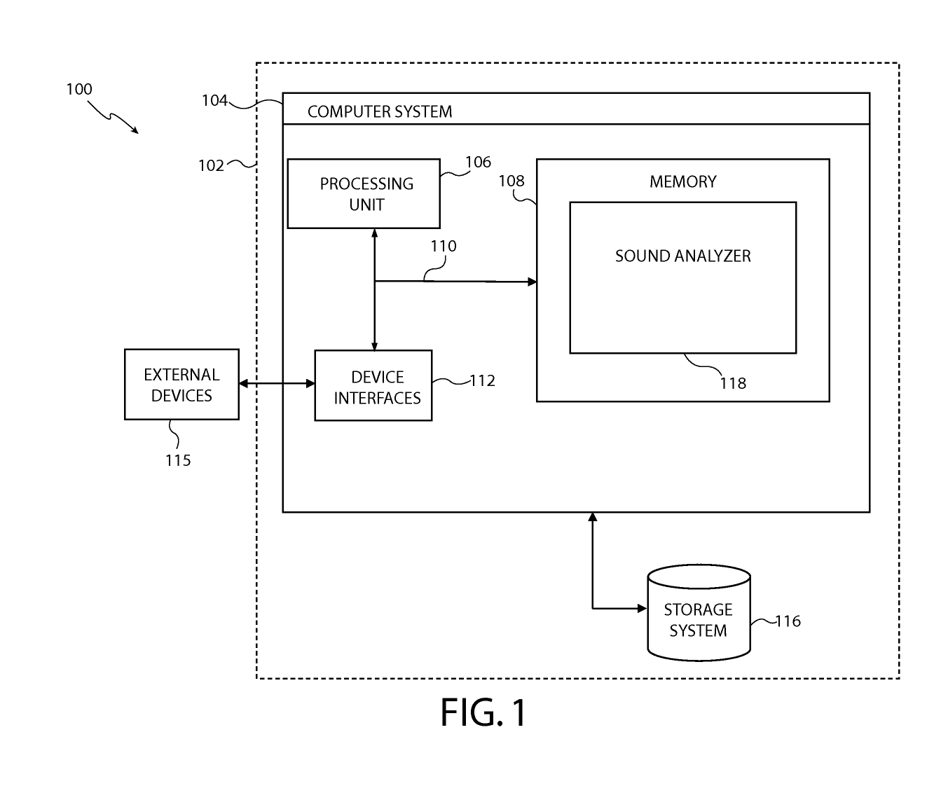

Referring now to FIG. 1, a computerized implementation 100 of the present invention will be described in greater detail. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), a cloud-computing environment, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for analyzing and transmitting environmental sounds. It should be understood that any other computers implemented under the present invention may have different components/software, but will perform similar functions. As shown, computer system 104 includes a processing unit 106 capable of communicating with a sound analyzer 118 stored in memory 108, a bus 110, and device interfaces 112.

Processing unit 106 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 106 collects and routes signals representing inputs and outputs between external devices 115 and sound analyzer 118. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different sensor systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating sound analyzer 118, which is stored in memory 108 and/or storage system 116. While executing computer program code, processing unit 106 can read and/or write data to/from memory 108, storage system 116, and sound analyzer 118. Storage system 116 can include VCRs, DVRs, RAID arrays, USB hard drives, optical disk recorders, flash storage devices, and/or any other data processing and storage elements for storing and/or processing data. Although not shown, computer system 104 could also include I/O interfaces that communicate with one or more external devices 115 that enable interaction with computer system 104 (e.g., sensors, speakers, a keyboard, a pointing device, a display, etc.).

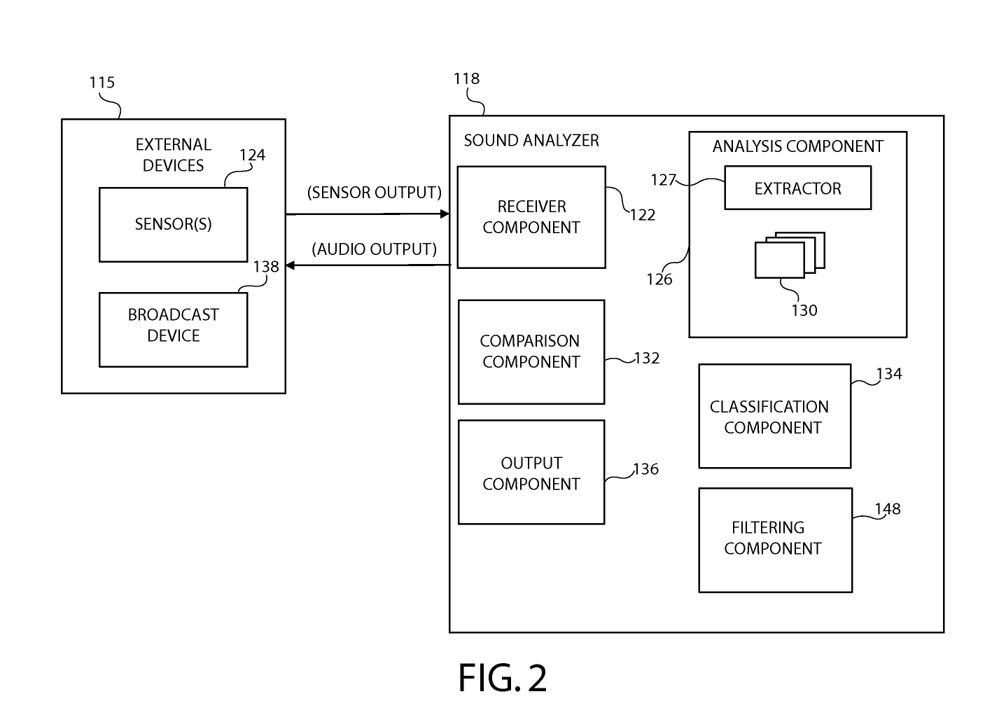

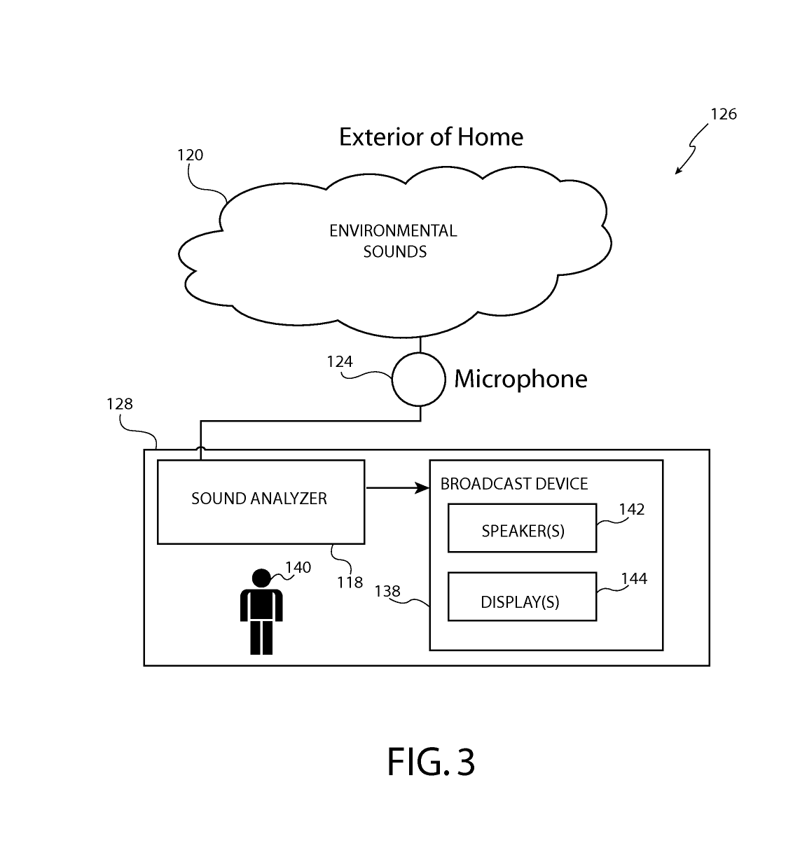

Referring now to FIGS. 2-3, operation of sound analyzer 118 will be described in greater detail. As shown, FIG. 2 is a block diagram illustrating an example of a combination of processing components that can be used for implementing sound analyzer 118 in implementation 100 illustrated in FIG. 1. In an exemplary embodiment, sound analyzer 118 operates with external devices 115 to receive, analyze and transmit environmental sounds 120 (FIG. 3). To accomplish this, sound analyzer 118 comprises a receiver component 122 configured to receive a sensor output from a sensor 124, the sensor output containing a set of environmental sounds 120, e.g., outdoor sounds generated from an environment 126 surrounding an enclosure 128 (FIG. 3).

In one embodiment, sensor 124 is a uni-directional microphone capable of recognizing the source and direction of environmental sounds 120 within a given radius. However, it will be appreciated that sensor 124 is not limited to any specific device and may include any type of sound transducer suited to the environment 126 (e.g. a microphone, a hydrophone) and suited to the expected properties (e.g. pitch) of the sounds from humans, cars, animals, etc., within environment 126. Sensor 124 may also include sensors of other kinds, depending on the application. For example, sensors 124 may include image capture devices such as still or video cameras (e.g. providing information regarding human/animal behavior via scene analysis/motion detection techniques), physiological sensors (e.g., pheromone sensors measuring the human/animal's heart rate, blood pressure, body temperature, etc., sensors, such as devices generating EEGs or functional MRI scans, which monitor brain activity), and movement sensors (e.g. microwave and passive infrared devices that detect movement wirelessly).

In some embodiments, sensors 124 may also include devices which measure properties of environment 126, such as light levels, ambient temperature, pollution, concentration of a given gas (e.g. CO2), etc. Data from these environmental sensors can help to interpret sound data coming from the other sensor(s) so that a more accurate determination can be made as to what sound and behavior the human/animal/object is currently exhibiting.

In general, sensors 124 are set up to operate continuously so that sounds and activity are monitored without interruption. However, sensors 124 may also be arranged so as to receive sounds during a set time period each day (e.g., from 8pm to 7am), or manually as desired by an operator. In another embodiment, where multiple sensors are used, a first sensor may operate continuously (or at a selected measurement frequency), while one or more other sensors are in a standby mode and operated as desired.

As further shown, sound analyzer 118 comprises an analysis component 126 configured to analyze environmental sounds 120 to determine attributes of each sound. Specifically, sound analysis component 126 is programmed to apply any necessary pre-processing to each type of sensor output signal, according to its type, and further process the signals to identify meaningful portions that can be isolated and considered to be individual sound samples (e.g., a human voice, an animal cry, song or call or, more generally, a particular behavior). Analysis component 126 is configured to process the received sensor data in order to define a set of attributes 130 for each environmental sound, wherein the attributes describe the individual sound samples.

As shown, analysis component 126 further comprises an extractor 127 configured to identify, within the output signal stream produced by sensor 124, segments which can be considered to correspond to separate sounds. It will be appreciated that the nature and operation of the extractor 127 can vary depending on the application and, in particular, on the number and nature of sensors 124. In one case, where the sensors 124 includes only a single audio sensor, extractor 127 may employ techniques known from the field of voice recognition and the like in order to identify, within the output signal stream produced by sensor 124, segments which can be considered to correspond to separate sounds, voices, etc. One example of a suitable segmentation technique is an analysis of the energy variations (i.e. the maxima and minima) of the short-term spectrum of the measured sound signal. However, this embodiment is not limited to use of any particular technique. Instead, other sound segmentation techniques, e.g., onset detection techniques, correlation techniques, Hidden Markov Model-based techniques, etc., may be used.

In one embodiment, extractor 127 receives a set of two or more signal streams as its input and seeks to find time intervals where the set of sensor signals indicates that a meaningful event is taking place, e.g., the monitored animal(s) is(are) exhibiting a particular type of behavior. It may be considered that each signal-stream processed by extractor 127 constitutes a separate channel. This case occurs, e.g., when sensors 124 include other types of sensors in addition to an audio sensor. However, it also covers the case where multiple audio sensors are arranged around environment 126 containing the target(s) to be monitored, so as to ensure that all relevant sounds are captured. In such a case, extractor 127 may be configured to process the output signal from each audio sensor as a separate channel, but other arrangements are possible. For example, extractor 127 may be configured to process only the strongest audio signal received by the set of audio sensors. Alternatively, if multiples of a given type of sensor are arranged around the detection region in order to ensure that all interesting data of a given type is captured, extractor 127 may process data from each such sensor as a separate channel, processing merely the strongest output, and averaging the outputs from the sensors of the same type, etc.

A variety of techniques may be used to identify sounds and attributes within a set of sensor-signal streams. One approach consists of measuring the degree of coordination between multiple signals from different sensors. In another approach, extractor 127 may be configured so as to base the segmentation on the variations observed in signals on a predetermined channel (or a set of the channels). In some applications, the segmentation will be based on input from the audio sensor(s). As another example, extractor 127 may be configured to segment each channel separately and, afterwards, events can be identified in different ways, one of which is to compare the timing of the events identified for the different channels (e.g., determine a set of time periods when all the channels (or a sub-set of the channels) are considered to have events occurring, or determine a channel in which events are identified with a high degree of confidence, etc.).

When extractor 127 has identified an attribute in the sensor signals, extractor 127 then identifies the relevant portion(s) of the sensor signal(s) that corresponds to that attribute. Typically, extractor 127 will forward the actual sensor-signal data that corresponds to the identified attribute. In exemplary embodiments, the attributes may comprise sounds from wildlife/animals, humans, automobiles, airplanes, or a detected lack of significant sound. Extractor 127 can be configured to collect sensor-signal data over a period of time and, at the end of the time period, analyze the collected sensor-signal data so as to detect any events occurring within the time interval.

During operation, extractor 127 is configured to produce set of attributes 130 about each environmental sound 120, i.e., descriptors of the sensor output signals that correspond to a given identified sound and/or event. Generally, an attribute consists of a feature and a corresponding value for this feature. For example a feature defining the average pitch of an audio signal segment corresponding to an event could consist of the attribute <average pitch> and the value data: <28.4 kHz>. Typically, features will be generated separately for the different channels (sensor outputs) and environmental sounds, but embodiments herein also cover the case of composite features, which are derived from processing together the output signals from two or more sensors (including sensors of different kinds).

In the case of audio sensor outputs, typical attributes that may be calculated for an audio segment include:
the pitch of the audio segment as evaluated during a portion of the sound signal waveform (e.g., derived by determining the most prominent peak in the Fourier transform);
the energy of the audio segment;
the “noisiness” of the segment (e.g. found by computing spectral flatness);
the “percussivity” (found, for example, by analyzing the energy of the attack portion of the waveform);
the “timbre” of the sound (for example, modeled by its Mel Frequency Cepstrum Coefficients);
the frequency bandwidth of the audio segment; and
the duration of the audio segment.

Once attributes 130 are identified for each environmental sound 120, attributes 130 are then sent to a comparison component 132, which is configured to compare attributes 130 to a collection of known sounds, i.e., pre-established/identified sounds stored in storage system 116 (FIG. 1). In one embodiment, storage system 116 is a database of natural outdoor sounds and previously recorded household sounds (e.g., family members, dog, automobiles, etc.). Based on the comparison, comparison component 132 seeks to describe each event using attributes/features taken from the predetermined set of sounds, e.g., the attributes that were used to define sound and event categories during a preliminary input and learning phase. When analysis component 126 has determined that attributes 130 describe a given environmental sound 120, it supplies the data to a classification component 134 configured to classify each environmental sound 120 based on the comparison of attributes 130 to the collection of known sounds. In one embodiment, classification component 134 identifies each of the environmental sounds 120 as one of: a recognized sound, or an unrecognized sound. That is, those attributes that match entries within storage system 116 of previously recorded sounds, are classified as known, and can be processed accordingly, while those attributes that do not generate a match are classified as unrecognized.

In one embodiment, unrecognized sounds include sound variations to the norm, for example, a different car noise in the driveway, a different voice on the property, etc. In one case, if children are playing in the yard, indoor occupant 140 might be alerted to a male's voice on the property or an unusually loud noise. The ‘lack’ of noise or long periods of silence might also alert indoor occupant 140. For example, if the sound of the children's voices becomes silent for some period of time, indoor occupant 140 might be alerted to the situation, as the child may have traveled outside the listening radius of sensor 124 or been injured.

Aspects of the attribute-extraction and classification functions that are performed by analysis component 126, comparison component 132 and classification component 134 will now be described in greater detail. In exemplary embodiments, it is desirable to develop a collection of known sounds, attributes, and categories during an initial input and training phase in order to establish the sounds and categories that may be compared against environmental sounds 120 during operation. Classification component 134 may develop a classification model, i.e., a set of definitions of categories, which may be assigned to the sounds and events that the system is liable to detect during subsequent operation. The classification model may consist of explicit data defining attributes, which characterize different categories, or it may be implicit in the structure of a trained classifier (e.g. in a discrimination tree, or a trained neural network). In general, the categories will depend on the intended application of the interaction system, notably, on the intended target(s) monitored and on the kinds of behavior that the target(s) may display.

A wide variety of different machine learning techniques may be used to develop the classification model from measured sensor signals and user-supplied sound/category/timing information. It will be appreciated that the measured sensor signals and the associated user-defined categories serve as training data that is used to train one or more classifiers. The training process involves an explicit or implicit analysis of the features of the sensor signals relating to events of different (known) categories, in order to determine the features that serve to differentiate instances of one category from instances of other categories.

The machine learning process may involve evaluation, for each sound, of the values of a predetermined set of attributes (e.g., values for: the number of harmonics, the frequency bandwidth, the amplitude, the duration, the zero crossing rate, etc., of sound sensor signals defining an event), followed by processing of the resultant attribute sets for the different events in order to determine which of these attributes (or combinations of these attributes) best serves to differentiate instances of the different categories from instances of the other categories. Alternatively, the machine learning process may itself determine, automatically, attributes of the sensor signals, which can be quantified so as to produce features that differentiate instances of different categories from one another.

After each environmental sound 120 is classified, they are sent to an output component 136 configured to output one or more of environmental sounds 120 and/or output information about the one or more of the environmental sounds. In one embodiment, output component 136 broadcasts, via a broadcast device 138 (FIG. 3), the environmental sounds to indoor occupant 140 within enclosure 128. Broadcast device 138 may comprise a speaker 142 and a display 144 for relaying the environmental sounds to indoor occupant 140 along with a visual display of the information about the environmental sounds (e.g., a textual graphic shown on display 144 identifying a person, animal, automobile engine, etc.). Broadcasting may be controlled by indoor occupant 140, thus allowing the timing, location, and nature of the broadcast to be selected and modified as desired. For example, indoor occupant 140 may dictate which rooms (not shown) within enclosure 128 to broadcast the audio output to, the time of day to enable broadcasting, and whether the audio output is to be stored for later use and/or analysis.

In a preferred embodiment, the audio output relayed by broadcast device 138 is intended to closely replicate environmental sounds 120 made by the humans, animals, automobiles, etc., being monitored in environment 126. Accordingly, the sound selector may be configured to control the sound output device so that it generates sounds that have the same acoustic properties as sounds made by the target(s) being monitored. The selected audio response can be synthesized and amplified, as necessary, to produce an accurate sound.

In another embodiment, the audio output containing environmental sounds 120 is filtered by a filtering component 148, which is configured to modify the audio output to emphasize (or de-emphasize) one or more of the environmental sounds. For example, indoor occupant 140 may simply want to hear birdcalls surrounding enclosure 128 while filtering out all other sounds. To accomplish this, filtering component 148 may comprise a high-pass filter to avoid picking up low frequency background noise from sensor 124. In this case, low-pass and high-pass filters may be employed to help reduce noise. For example, most bird vocalizations can be observed in approximately a 1,200 Hz-8,000 Hz range. Use of low-pass and high-pass filters at the analog input stage can improve the quality of the signal being analyzed by removing portions unlikely to be part of a bird vocalization.

In another embodiment, filtering component 148 comprises one or more digital filters, which may be applied to the sensor output signal to further reduce background noise and enhance the signal strength of one or more of environmental sounds 120 (e.g., a particular human voice or animal sound). In this case, common sources of noise can be identified and eliminated from the signal electronically using any suitable techniques, including those commonly applied to voice and telephony applications. For example, noise reduction can be achieved by measuring the background noise power levels in each discrete frequency bin produced by a Fast Fourier Transform algorithm, and subtracting the background levels from the signal. This technique is commonly referred to as spectral subtraction. Echo cancellation techniques can also be applied to eliminate noise caused by the echo of vocalizations off objects such as trees, boulders, and man-made structures.

Many sources of noise in an open field can be described as “pink noise”, meaning that the power levels of noise are inversely proportional to frequency. By applying a pink noise filter to the input, lower frequencies can be attenuated more than higher frequencies. Also, other noise profiles are possible that can be predetermined, or can be determined by field measurements, or can be determined by any other suitable method. When a noise profile can be determined, a suitable filter can then be selected or designed and applied to the input, attenuating frequencies at which the noise occurs more than frequencies at which the signal occurs.

### ILLUSTRATIVE EXAMPLES

Referring again to FIGS. 2-3, the following non-limiting use cases are described in light of the embodiments provided herein.

Use Case Scenario 1: Joe (i.e., indoor occupant 140) is at his cottage (i.e., enclosure 128). It is winter and Joe has no windows open to conserve heat. Joe has a number of outdoor bird feeders on his property. Today Joe sees through his window that a number of birds have flocked to his feeder. Joe turns on sensor(s) 124 and activates sound analyzer 118. He then requests sound analyzer 118 to provide him with details on the types of bird sounds being received. Output component 136 relays the bird sounds in real time via a speaker into Joe's cottage. Using analytics based on the bird song patterns and characteristics, sound analyzer 118 is able to determine that there is an Oriole at the feeder, and displays this data on display 144 for Joe to read.

Use Case Scenario 2: Elizabeth (i.e., indoor occupant 140) has two small children, Angela and Kelly, whose voices were previously captured and stored by sound analyzer 118. Both children are playing in the backyard (i.e., environment 126 surrounding enclosure 128) while Elizabeth is preparing dinner. Elizabeth turns on her sensor(s) 124 and activates sound analyzer 118 to monitor the children. Elizabeth selects an option to be alerted if sound analyzer 118 classifies any received sound as ‘unknown’, i.e., any voices other then Angela's and Kelly's. While washing dishes, broadcast device 138 alerts Elizabeth via speaker 142 that an additional male voice is detected in a close proximately to enclosure 128. Elizabeth immediately goes outside to investigate. Upon arrival she sees that it is a local salesman asking the girls if their mother is home.

Use Case Scenario 3: Susan (i.e., indoor occupant 140) is preparing for her husband Tom's surprise 50th birthday party. She has a number of guests in enclosure 128 and wants them to hide and yell ‘happy birthday’ upon Tom's arrival into the home. To ensure the surprise goes off just as planned, Susan requests to be notified when Tom's car is detected in the driveway by sensor(s) 124. When Tom's car pulls into the driveway, sound analyzer 118 recognizes his particular engine sounds and indicates, in an automated voice, that Tom has arrived.

Use Case Scenario 4: In the classroom setting in colder climates, a science class learning about various local wildlife can use this system indoors while monitoring local outdoor sounds. When a particular local bird or animal is identified, the teacher can be alerted to then broadcast, in real time, the sound to the students and make the children aware of the animal or bird characteristics, further enhancing the learning experience.

Use Case Scenario 5: In the identification of new or rare species, remote users might share their recordings with local environmental groups looking to identify the migration of rare or presumed extinct birds or animals. Therefore, an alert might be displayed if a recording captures the sound of a rare, new (e.g., based on a database of prerecorded species) or of what was thought to be an extinct species.

As described herein, the present invention provides for capturing, analyzing, and then transmitting outdoor environmental sounds to an indoor recipient. It can be appreciated that the approaches disclosed herein can be used within a computer system for analyzing and transmitting environmental sounds, as shown in FIG. 1. In this case, sound analyzer 118 can be provided, and one or more systems for performing the processes described in the invention can be obtained and deployed to computer infrastructure 102. To this extent, the deployment can comprise one or more of: (1) installing program code on a data center device, such as a computer system, from a computer-readable storage medium; (2) adding one or more data center devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

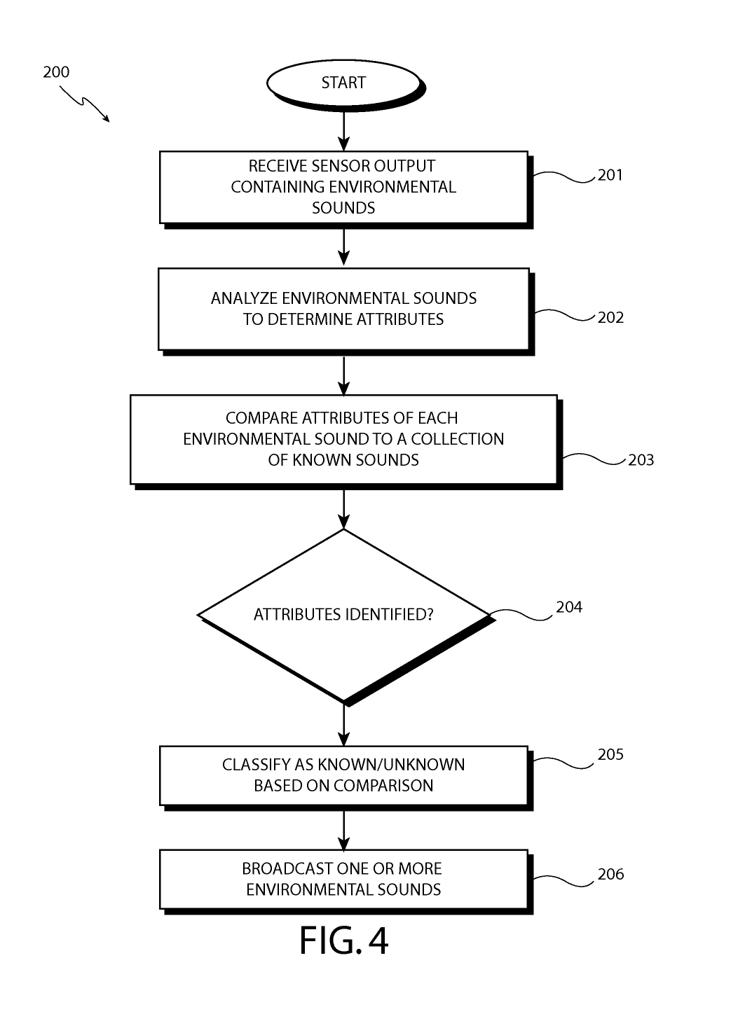

The program modules carry out the methodologies disclosed herein, as shown in FIG. 4. Shown is a process 200 for analyzing and transmitting environmental sounds, wherein, at 201, a sensor output containing environmental sounds is received. At 202, the environmental sounds are analyzed to determine attributes of each of the environmental sounds. At 203, each of the attributes is compared to a collection of known sounds. At 204, it is determined whether the attributes are identified based on the comparison. At 205, the environmental sounds are classified as known or unknown based on the comparison. Next, at 206, one or more of the environmental sounds are broadcast to an indoor occupant within the enclosure.

The flowchart of FIG. 4 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, as will be described herein, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations.

For example, an implementation of exemplary computer system 104 (FIG. 1) may be stored on or transmitted across some form of computer readable media. Computer readable media can be any available media that can be accessed by a computer. By way of example, and not limitation, computer readable media may comprise “computer storage media” and “communications media.”

“Computer-readable storage device” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided an approach for analyzing and transmitting environmental sounds. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for analyzing and transmitting environmental sounds, the method comprising the computer-implemented steps of:
receiving a sensor output containing a set of environmental sounds;
analyzing the set of environmental sounds to determine attributes of each of the set of environmental sounds;
comparing the attributes of each of the set of environmental sounds to a collection of known sounds;
classifying each of the set of environmental sounds based on the comparison of the attributes of each of the set of environmental sounds to the collection of known sounds; and
outputting one or more of the set of environmental sounds.

2. The method according to claim 1, further comprising the computer-implemented step of outputting information about one or more of the set of environmental sounds.

3. The method according to claim 1, further comprising the computer-implemented step of receiving a set of broadcast preferences from a user.

4. The method according to claim 2, further comprising the computer-implemented step of broadcasting to a user, in real-time, at least one of: an audio transmission of the one or more of the set of environmental sounds, and a visual display of the information about one or more of the set of environmental sounds.

5. The method according to claim 1, the computer-implemented step of classifying further comprising identifying each of the set of environmental sounds as one of: a recognized sound, and an unrecognized sound.

6. The method according to claim 1, further comprising the computer-implemented step of modifying the audio output to emphasize one or more of the set of environmental sounds.

7. The method according to claim 1, wherein the set of environmental sounds comprises one or more sounds from an exterior area of an enclosure.

8. The method according to claim 7, wherein the sounds from the exterior of the enclosure are transmitted to a broadcast device within an interior of the enclosure.

9. A computer system for analyzing and transmitting environmental sounds, the system comprising:
at least one processing unit;
memory operably associated with the at least one processing unit; and
a sound analyzer storable in memory and executable by the at least one processing unit, the sound analyzer comprising:
a receiver component configured to receive an audio output containing a set of environmental sounds;
an analysis component configured to analyze the set of environmental sounds to determine attributes of each of the set of environmental sounds;
a comparison component configured to compare the attributes of each of the set of environmental sounds to a collection of known sounds;
a classification component configured to classify each of the set of environmental sounds based on the comparison of the attributes of each of the set of environmental sounds to the collection of known sounds; and
an output component configured to output one or more of the set of environmental sounds.

10. The computer system according to claim 9, the output component further configured to output information about the one or more of the set of environmental sounds.

11. The computer system according to claim 10, the output component further configured to broadcast to a user, according to a set of broadcast preferences received from the user, at least one of: an audio transmission of the one or more of the set of environmental sounds, and a visual display of the information about one or more of the set of environmental sounds.

12. The computer system according to claim 9, the classification component further configured to identify each of the set of environmental sounds as one of: a recognized sound, and an unrecognized sound.

13. The computer system according to claim 9, further comprising a filtering component configured to modify the audio output to emphasize one or more of the set of environmental sounds.

14. The computer system according to claim 9, wherein the set of environmental sounds comprises one or more sounds from an exterior area of an enclosure, and wherein the sounds from the exterior of the enclosure are transmitted to an output device within an interior of the enclosure.

15. A computer-readable storage medium storing computer instructions, which when executed, enables a computer system to analyze and transmit environmental sounds, the computer instructions comprising:
receiving a sensor output containing a set of environmental sounds;
analyzing the set of environmental sounds to determine attributes of each of the set of environmental sounds;
comparing the attributes of each of the set of environmental sounds to a collection of known sounds;
classifying each of the set of environmental sounds based on the comparison of the attributes of each of the set of environmental sounds to the collection of known sounds; and
outputting one or more of the set of environmental sounds.

16. The computer-readable storage medium according to claim 15, further comprising computer instructions for outputting information about one or more of the set of environmental sounds.

17. The computer-readable storage medium according to claim 16, further comprising computer instructions for broadcasting to a user, according to a set of broadcast preferences received from the user, at least one of: an audio transmission of the one or more of the set of environmental sounds, and a visual display of the information about one or more of the set of environmental sounds.

18. The computer-readable storage medium according to claim 15, the computer instructions for classifying further comprising instructions for identifying each of the set of environmental sounds as one of: a recognized sound, and an unrecognized sound.

19. The computer-readable storage medium according to claim 15, further comprising computer instructions for modifying the audio output to emphasize one or more of the set of environmental sounds.

20. The computer-readable storage medium according to claim 15, wherein the set of environmental sounds comprises one or more sounds from an exterior area of an enclosure, and wherein the sounds from the exterior of the enclosure are transmitted to an output device within an interior of the enclosure.
